(19) United States
(12) Patent Application Publication
(10) Pub. No.: US 2008/0254656 A1
(43) Pub. Date: Oct. 16, 2008

(54) Connector module and electronic device using the same

(75) Inventors: Chih-Chung Lin, Taipei (TW); Jiann-Hui Liu, Taipei (TW); Hong-Hai Lu, Taipei (TW)

Correspondence Address: BACON & THOMAS, PLLC, 625 SLATERS LANE, FOURTH FLOOR, ALEXANDRIA, VA, 22314-1176, US

(73) Assignee: ASUSTek COMPUTER INC., Taipei (TW)

(21) Appl. No.: 12/078,595

(22) Filed: Apr. 2, 2008

(30) Foreign Application Priority Data
Apr. 4, 2007 (TW) 96112132

(51) Int. Cl. H01R 13/648

(52) U.S. Cl. 439/98

(57) ABSTRACT

A connector module is coupled to a ground terminal to discharge accumulated charges. The connector module includes a connector and a metallic housing. The connector has a connecting port. The metallic housing is covered over the connector. The metallic housing has a contact surface as the ground terminal and a flexible portion protruding from the contact surface contacts the ground terminal to discharge the accumulated charges to decrease the electromagnetic interference (EMI) problems, and malfunctions of electronic system caused by electrostatic discharge (ESD) are also decreased. The stability and the reliability of the connector module are thus ensured.

This application claims the benefit of Taiwan application Serial No. 96112132, filed Apr. 4, 2007, the subject matter of which is incorporated herein by reference.

### BACKGROUND OF THE INVENTION

1. Field of the Invention

The invention relates to a connector module and an electronic device using the same and, more particularly, to a connector module which can decrease electromagnetic interference and an electronic device using the same.

2. Description of the Related Art

Most countries have established definite regulations on electromagnetic compatibility (EMC) of electronic devices at present, and strict limitations are further established in developed countries such as America, Japan, and the countries in Europe. Therefore, related tests aiming at EMC of electronic devices should be done during the stage of research and development to comply with the regulations in the countries with marketability.

For example, the audio or video connectors commonly used in a television or a digital set-up box such as Syndicat des Constructeurs d'Appareils. Radiorécepteurs et Téléviseurs (SCART) connectors, are mostly covered by plastic outer housings. Therefore, the efficiency of the electrical connections between the connectors and the outer housings would be low. Therefore, the electric charge is accumulated and the electromagnetic interference (EMI) is thus occurred. Furthermore, the electrostatic discharge (ESD) events result degradation functions and other problems of electronic devices.

### BRIEF SUMMARY OF THE INVENTION

The invention relates to a connector module and an electronic device having the connector module. A metallic housing covers the body of a connector, and a flexible portion having elasticity is provided on the metallic housing. The electric charge of the connector is conduct to the outer housing via the flexible portion to discharge charges, therefore the electromagnetic interference (EMI) and the electrostatic discharge (ESD) problems are greatly reduced.

A connector module according to a preferred embodiment of the invention is provided, the accumulated charges on the connector module is discharge to a ground terminal. In a preferred embodiment of the invention, the ground terminal can be, for example, the outer housing of an electronic device. The connector is preferably a Syndicat des Constructeurs d'Appareils. Radiorécepteurs et Téléviseurs (SCART) connector.

An electronic device is provided according to another preferred embodiment of the invention, and the electronic device includes an outer housing and a connector module. The outer housing has an opening, and the size of the opening is equal to that of the connector module, and the connector module is exposed from the opening.

The connector module of a preferred embodiment of the invention includes a connector and a metallic housing. The connector includes a connecting port, and the metallic housing is used to hold the connector. In a preferred embodiment, the metallic housing has a contact surface, and a flexible portion is protruding from the contact surface and contacts the ground terminal or the outer housing.

The number of connecting ports of the connector is not limited, such as one connector, or two connectors including an input port and an output port. The flexible portion and the metallic housing are preferred to be integrally formed, and the flexible portion is further preferred a spring finger. In a preferred embodiment of the invention, more than two flexible portions are provided and preferred to be symmetrically disposed on the metallic housing. In addition, there is no limitation on the connection mode of the connector and the metallic housing in the embodiment of the invention, however, the connection mode is preferred a screw connection mode or a fastening mode.

In the connector module and the electronic device as disclosed in one embodiment of the invention, a metallic housing is provided at the body of a connector, and a flexible portion directly contact a ground terminal to discharge accumulated charges provided at the metallic housing, thus to decrease EMI problems. Hence, the problem of degradation functions of the electronic system caused by ESD is reduced, and the stability and the reliability of the connector are improved.

These and other features, aspects, and advantages of the present invention will become better understood with regard to the following description, appended claims, and accompanying drawings.

### BRIEF DESCRIPTION OF THE DRAWINGS

FIG. 1A is a front view showing an electronic device according to a preferred embodiment of the invention.

FIG. 1B is a back view showing an electronic device according to a preferred embodiment of the invention.

FIG. 2 is a schematic diagram showing a connector module according to a preferred embodiment of the invention.

FIG. 3A is a front view showing the metallic housing of a connector module.

FIG. 3B is a lateral view showing the metallic housing of a connector module.

FIG. 4 is a front view showing the connector of a connector module.

### DETAILED DESCRIPTION OF THE INVENTION

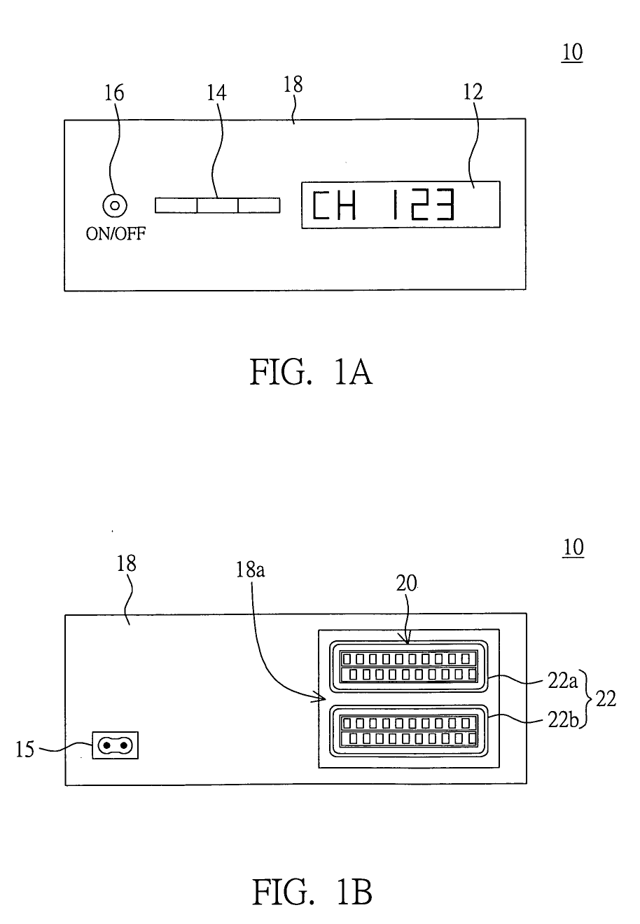

Please refer to FIGS. 1A and 1B, a front view and a back view of an electronic device according to a preferred embodiment of the invention are showed respectively. The electronic device is, for example, a television, a display or a set-top box as an example in the present embodiment. As shown in FIG. 1A, the electronic device 10 includes a light emitting diode (LED) display 12, a control key 14 and a power light 16 which are all disposed on an outer housing 18. The outer housing 18 is made of metal or is a plastic housing which is lined with metal inside.

As shown in FIG. 1B, a power socket 15 and a connector module 20 are disposed on the outer housing 18. The connector module 20 comprises such as a Syndicat des Constructeurs d'Appareils Radiorécepteurs et Téléviseurs (SCART) connector that having a connecting port 22. The connecting port 22 have an input port 22a and an output port 22b for inputting and outputting audio and video signals, respectively. The outer housing 18 has an opening 18a from which the connector module 20 is exposed. Furthermore, the outer housing 18 as a ground terminal is coupled to the connector module 20 to discharge accumulated charges to avoid generating an electrostatic surge.

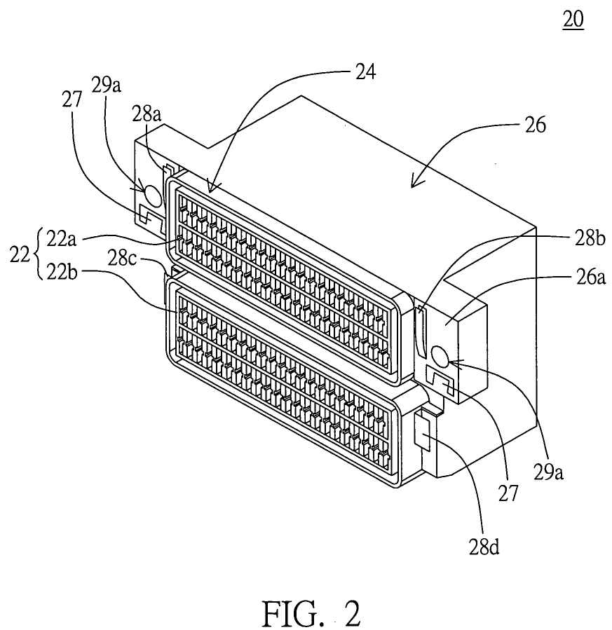

Please refer to FIG. 2, which is a schematic diagram showing a connector module according to a preferred embodiment of the invention. The connector module 20 consists of a connector 24 and a metallic housing 26. The connector 24 has connecting ports 22 including the input port 22a and the output port 22b. The metallic housing 26 includes flexible portions 28a, 28b, 28c and 28d to hold the connector 24. The flexible portions 28b and 28d of the metallic housing 26 can directly contact the outer housing 18 in FIG. 1B, and the size of the opening 18a of the outer housing 18 is equal to that of the connector 24.

In addition, in the embodiment, the flexible portions 28a and 28b are symmetrically disposed on two sides of the metallic housing 26, located at two sides of the input port 22a while the connector 24 is assembled. The flexible portion 28c and 28d are also symmetrically disposed on the two sides of the metallic housing 26, located at two sides of the output port 22b while the connector 24 is assembled. Disposing the flexible portions symmetrical allows the amounts of the accumulated charges equally at the two sides of the metallic housing 26, thus to avoid the additional electromagnetic waves occur by charge difference, and the interference on the connector 24 is decreased.

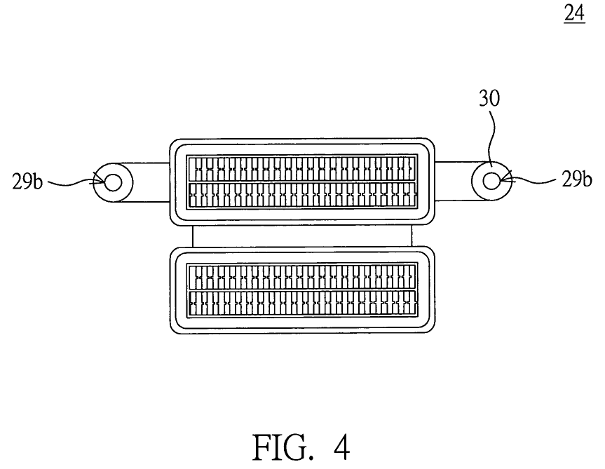

In addition, the metallic housing 26 further includes a fastening spring finger 27. When the connector 24 is disposed in the metallic housing 26, the fastening spring finger 27 against the protruding portion 30 itself (As shown in FIG. 4, which is a front view showing the connector of a connector module.) of the connector 24 or the lower edge of the protruding portion 30. The connector 24 is secured and via the mutual interference between the protruding portion 30 and the fastening spring finger 27. In addition, the metallic housing 26 further has a screw hole 29a, which can be selectively locked with the screw hole 29b of the connector 24 by a screw.

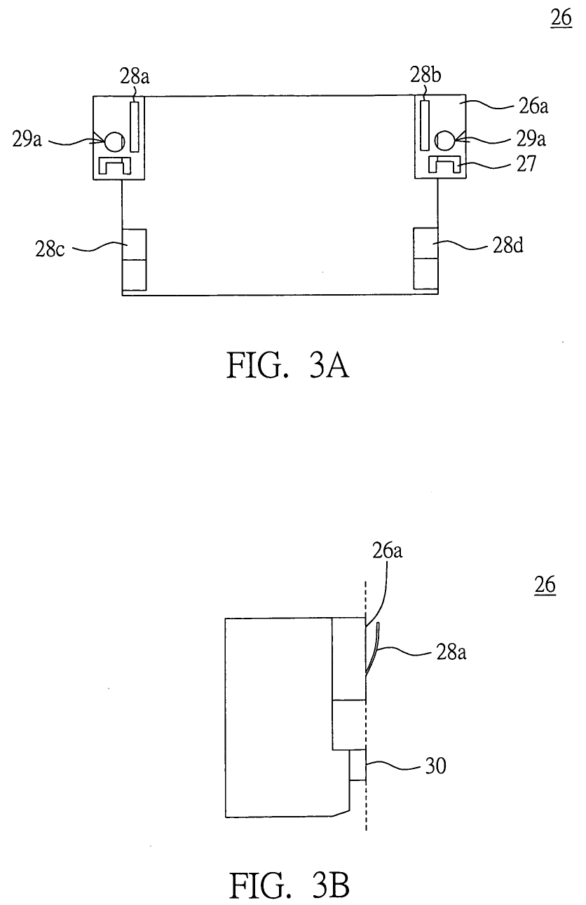

Please refer to FIG. 3A, which is a front view showing the metallic housing of a connector module. The metallic housing 26 has a contact surface 26a, and the flexible portions 28a, 28b, 28c and 28d protrude from the surface where the contact surface 26a is, so that when the contact surface 26a of the metallic housing 26 is against the outer housing 18 shown in FIG. 1A, it certainly contacts with the outer housing 18 to discharge the accumulated charges to the outer housing 18 to decrease electromagnetic interface (EMI) and electrostatic discharge (ESD) problems in the interior of the electronic device 10.

In the embodiment, the metallic housing 26 and the flexible portions 28a, 28b, 28c and 28d are integrally formed. The flexible portions 28a, 28b, 28c and 28d are spring fingers configured by cutting and bending the metallic housing 26 above the contact surface 26a. As shown in FIG. 3B, the flexible portions 28a, 28b, 28c and 28d can certainly contact the outer housing 18 via the spring finger configuration.

In addition, the connector 24 and the metallic housing 26 is assembled by connecting the screw hole 29b of the connector 24 as shown in FIG. 4 and the screw hole 29a of the metallic housing 26 as shown in FIG. 3A.

Certainly, artisans know that the invention is not limited by the description of the embodiments. As long as the flexible portions are conductors and disposed on the metallic housing to couple firmly, they are within the scope of the invention. There is no special limitation on the shape, the size, the number and the position of the flexible portions, and the flexible portions can be disposed at the top, bottom or inner of the metallic housing. Furthermore, the metallic housing is not limited to a casing, it also can be a metallic frame or any conductive ones. If the flexible portions are provided in pairs, the electromagnetic waves generated from unbalance of the accumulated charges can be decreased.

In the connector module and the electronic device as disclosed above, a metallic housing is provided at the body of the connector, and flexible portions directly contact the ground terminal to discharge accumulated charges provided at the metallic housing, thus to decrease EMI problems. Hence, the problem of faulty actions of the electronic system caused by ESD is reduced, and the stability and the reliability of the connector are improved. Results of experiments show that using the SCART connector module of the invention can decrease about 10 dB electromagnetic radiation and pass an electromagnetic compatibility test effectively, thus to avoid the electromagnetic waves influencing on human bodies or other electronic devices, and the signal transmission quality of the electronic device is thus ensured.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A connector module coupled to a ground terminal, the connector module comprising:
a connector having a connecting port; and
a metallic housing for holding the connector, the metallic housing having a contact surface, and a flexible portion protruding from the contact surface and contacting with the ground terminal.

2. The connector module according to claim 1, wherein the flexible portion and the metallic housing are integrally formed.

3. The connector module according to claim 1, wherein the flexible portion is a spring finger.

4. The connector module according to claim 1, wherein a second flexible portion is further comprised, the flexible portion and the second flexible portion are symmetrically disposed on the metallic housing.

5. The connector module according to claim 1, wherein the connector and the metallic housing are fastened.

6. The connector module according to claim 1, wherein the connector is a Syndicat des Constructeurs d'Appareils. Radiorécepteurs et Téléviseurs (SCART) connector.

7. The connector module according to claim 1, wherein the ground terminal is the outer housing of an electronic device.

8. An electronic device comprising:
an outer housing having an opening; and
a connector module coupled to the outer housing, the connector module comprising:
a connector having a connecting port; and
a metallic housing for holding the connector, the metallic housing having a contact surface and a flexible portion protruding from the contact surface;
wherein the flexible portion of the metallic housing directly contacts the outer housing, and the size of the opening of the outer housing is the same with that of the connector.

9. The electronic device according to claim 8, wherein the flexible portion and the metallic housing are integrally formed.

10. The electronic device according to claim 8, wherein the flexible portion is a spring finger.

11. The electronic device according to claim 8, wherein a second flexible portion is further comprised, the flexible portion and the second flexible portion are symmetrically disposed on the metallic housing.

12. The electronic device according to claim 8, wherein the connector and the metallic housing are fastened.

13. The electronic device according to claim 8, wherein the connector is a Syndicat des Constructeurs d'Appareils. Radiorécepteurs et Téléviseurs (SCART) connector.

14. The electronic device according to claim 8, wherein the electronic device is a set-top box, a television or a display.
